(19) United States
(12) Patent Application Publication
(10) Pub. No.: US 2022/0390041 A1
(43) Pub. Date: Dec. 8, 2022

(54) INTEGRATED BRACKET FOR FIXING SPRINKLER REDUCER WITH TOGGLE ONE-TOUCH MIDDLE BRACKET AND LENGTH-ADJUSTABLE END BRACKET

(71) Applicant: SY FLEX CO.,LTD., Seoul (KR)

(72) Inventor: Mi Jeong PARK, Seoul (KR)

(73) Assignee: SY FLEX CO.,LTD., Seoul (KR)

(21) Appl. No.: 17/550,929

(22) Filed: Dec. 14, 2021

Related U.S. Application Data
(63) Continuation of application No. PCT/KR2021/006853, filed on Jun. 2, 2021.

(51) Int. Cl. F16L 3/10; A62C 35/68

(52) U.S. Cl. CPC F16L 3/1075; A62C 35/68

(57) ABSTRACT

The present invention relates to an integrated bracket for fixing a sprinkler reducer, and more particularly, to an integrated bracket for fixing a sprinkler reducer, in which left and right portions of a bar-shaped steel frame structure for a sprinkler bracket are vertically bent, tightening/coupling parts are provided at two opposite ends of the steel frame structure, and a fixing unit having a new structure and serving as a middle bracket is integrated with a central portion of the steel frame structure, such that the single bar-shaped steel frame structure may perform a function of fixing the sprinkler reducer and coupling a ceiling steel frame.

### CROSS-REFERENCE TO RELATED APPLICATIONS

This application claims priority to and the benefit of International Patent Application No. PCT/KR2021/006853 filed with the Receiving Office (Korean Intellectual Property Office) on Jun. 2, 2021, the entire contents of which are incorporated herein by reference.

### TECHNICAL FIELD

The present invention relates to an integrated bracket for fixing a sprinkler reducer, and more particularly, to an integrated bracket for fixing a sprinkler reducer, in which left and right portions of a bar-shaped steel frame structure for a sprinkler bracket are vertically bent, tightening/coupling parts are provided at two opposite ends of the steel frame structure, and a fixing unit having a new structure and serving as a middle bracket is integrated with a central portion of the steel frame structure, such that the single bar-shaped steel frame structure may perform a function of fixing the sprinkler reducer and coupling a ceiling steel frame.

### BACKGROUND ART

In general, a sprinkler facility refers to an automatic fire extinguishing facility configured such that a fuse in a sprinkler head installed on an indoor ceiling textile is automatically cut in the event of a fire to spray water for extinguishing the fire and activates an alarm for occurrence of fire.

The sprinkler is installed on a ceiling of a building and configured to be supplied with and spray high-pressure water. To install the sprinklers, a main water supply tube for supplying water to the inside of the ceiling is installed, and the sprinklers are coupled to connection tubes that connect a plurality of branch water supply tubes to the main water supply tube. A flexible tube made of a metallic material, which is flexibly bendable, is widely used to connect the branch water supply tube and the sprinkler and supply the water.

An outer peripheral surface of the flexible tube is corrugated in a spiral shape so that the flexible tube is flexibly bent. To prevent damage to a tube body caused by a pressure of the high-pressure water flowing through the flexible tube, an O-ring and a fastening ring are securely fixed to a portion connected to the branch water supply tube. The flexible tube is connected between the branch water supply tube and a sprinkler spray nozzle and coupled to the sprinkler head by means of a tube fitting called a reducer.

In this case, to fix the sprinkler facility to the ceiling, it is necessary to couple the reducer to a ceiling steel frame that fixes the building ceiling textile. In general, various types of brackets are used to fix the reducer to the ceiling steel frame.

Specifically, a sprinkler reducer fixing bracket in the related art includes a center bracket for fixing the reducer in a particular direction (generally, a vertical direction), a quadrangular bar (or a horizontal support) for supporting the center bracket, and left and right side brackets (or vertical supports) serving as legs for connecting the ceiling steel frame and the quadrangular bar. That is, the sprinkler reducer fixing bracket in the related art includes the two side brackets, the single center bracket, and the single quadrangular bar.

The sprinkler reducer fixing bracket in the related art requires various connecting members such as screws, bolts, and fasteners for coupling the components. Further, the number of design factors such as coupling holes, sizes of connecting members, and yield strength between the components for coupling the several brackets increases, which causes a problem in that an excessive amount of costs are required to design and manufacture the sprinkler reducer fixing bracket.

Accordingly, there is a need to develop a sprinkler reducer fixing bracket that improves ease of design and manufacture and solves the above-mentioned problems by designing a structure in which the center bracket, the quadrangular bar, and the left and right side brackets are integrated.

### DOCUMENT OF RELATED ART

### Patent Document

U.S. Pat. No. 9,004,421

### DISCLOSURE

### Technical Problem

The present invention has been made in an effort to solve the above-mentioned problems, and an object of the present invention is to provide an integrated bracket for fixing a sprinkler reducer in which a reducer fixing bracket, a ceiling steel frame coupling bracket, and a connecting bracket are integrated.

Another object of the present invention is to provide an integrated bracket for fixing a sprinkler reducer, in which an integrated frame is configured by inserting and coupling one or more quadrangular bars such that a length of the integrated frame is adjustable.

Still another object of the present invention is to provide an integrated bracket for fixing a sprinkler reducer, in which the use of connecting members such as tightening screws and fasteners is minimized by integration.

Yet another object of the present invention is to provide an integrated bracket for fixing a sprinkler reducer, which is capable of easily fixing a sprinkler reducer by means of a special shape and a coupling structure of four guides constituting a fixing unit without a separate elastic body.

Still yet another object of the present invention is to provide an integrated bracket for fixing a sprinkler reducer, which is capable of applying both a hexagonal reducer and a quadrangular reducer by means of a special shape and a coupling structure of four guides constituting a fixing unit.

### Technical Solution

An integrated bracket for fixing a sprinkler reducer according to an embodiment of the present invention is installed on one or more ceiling steel frames, and the integrated bracket includes: an integrated frame having two opposite ends each having a bar shape bent at a right angle; and a fixing unit configured to fix the reducer.

In this case, the two opposite ends of the integrated frame may be coupled to the ceiling steel frame.

In this case, the fixing unit may be configured by coupling four guides and define an opening into which the reducer is inserted, such that the reducer inserted into the opening is pressed and fixed by the four guides.

In the embodiment, the fixing unit may include: a first guide coupled to the integrated frame by fitting; a second guide configured to come into close contact with the reducer inserted into the opening by an external force; a third guide serving as a handle to which the external force is applied by a user; and a fourth guide serving as a flat spring configured to fix positions of the second and third guides when the third guide approaches the second guide by the external force.

In this case, the first to fourth guides each have one or more coupling holes and include a pair of partition walls facing each other, and a connecting surface for connecting the pair of partition walls.

In the embodiment, the fixing unit may include: a first coupling pin configured to couple the first guide and the second guide; a second coupling pin configured to couple the second guide and the third guide; a third coupling pin configured to couple the third guide and the fourth guide; and a fourth coupling pin configured to couple the first guide and the fourth guide.

In this case, a length of each of the first to fourth coupling pins may correspond to a distance between the pair of partition walls constituting each of the first to fourth guides.

In the embodiment, when the third guide approaches the second guide by the external force, the third coupling pin may be accommodated between the pair of partition walls constituting the second guide, and a position of the second coupling pin may be moved to a portion between the coupling holes of the fourth guide.

In the embodiment, when the third guide approaches the second guide by the external force, the second guide may adjust a position of the reducer so that an outer surface of the reducer inserted into the opening comes into close contact with the first guide, and the second guide may press the reducer.

In the embodiment, the integrated frame may have a structure in which a plurality of quadrangular bars is inserted and coupled.

In the embodiment, the integrated frame may include: a first quadrangular bar having a space formed therein; and a second quadrangular bar having an outer surface compressed to have a reduced cross-section at one side thereof.

In this case, a compressed lateral portion of the second quadrangular bar may be inserted into and coupled to one side of the first quadrangular bar.

In the embodiment, the first and second quadrangular bars may slide in a longitudinal direction, and positions of the first and second quadrangular bars may be fixed by a fixing member.

In the embodiment, the integrated frame may include tightening/coupling parts provided at two opposite ends, and the tightening/coupling parts may each have a shape divided into a first leg portion and a second leg portion.

In the embodiment, the tightening/coupling part may have a concavo-convex coupling groove so that the ceiling steel frame is fixed by being inserted between the first leg portion and the second leg portion.

In the embodiment, the tightening/coupling part may include a tightening member configured to allow the first and second leg portions to press each other.

In another embodiment, the fixing unit may have openings into which the sprinkler reducer is inserted and include a pair of partition walls facing each other and respectively having the openings, and a connecting portion configured to connect the partition walls.

In another embodiment, the pair of partition walls may have a protruding portion for fixing the sprinkler reducer to the inside where the pair of partition walls face each other.

In another embodiment, the fixing unit may be positioned at a central portion in a longitudinal direction of the integrated frame.

### Advantageous Effects

According to the present invention, the reducer fixing module, the ceiling steel frame coupling module, and the supports between the modules are integrated, such that the use of the connecting members is minimized, and the number of design factors is increased. Therefore, it is possible to obtain an effect of reducing costs required to develop and manufacture the sprinkler reducer fixing bracket.

In addition, according to the present invention, the integrated frame is configured by inserting and coupling the one or more quadrangular bars, such that the length of the integrated frame may be adjusted, which makes it possible to use the integrated frame for the ceiling steel frames having various structures. Therefore, it is possible to obtain an effect of improving the convenience of use.

In addition, according to the present invention, it is possible to obtain an effect of easily fixing the sprinkler reducer by means of the special shape and the coupling structure of the four guides constituting the fixing unit without a separate elastic body.

In addition, according to the present invention, it is possible to obtain an effect of using the integrated bracket as a bracket for fixing a hexagonal sprinkler reducer and a quadrangular reducer by means of the special shape and the coupling structure of the four guides constituting the fixing unit.

### DESCRIPTION OF DRAWINGS

FIG. 1 is a view illustrating an integrated bracket for fixing a sprinkler reducer according to an embodiment of the present invention.

FIGS. 2A and 2B are perspective views illustrating a state in which a sprinkler reducer is fixed using a fixing unit (middle bracket) according to the embodiment of the present invention (FIG. 2A illustrates an opened state, and FIG. 2B illustrates a closed state).

FIGS. 3A and 3B are cross-sectional views illustrating a structure of the fixing unit according to the embodiment of the present invention (FIG. 3A illustrates an opened state, and FIG. 3B illustrates a closed state).

FIG. 4 is an exploded view illustrating a configuration and structure of the fixing unit according to the embodiment of the present invention.

FIG. 5A is a view illustrating a quadrangular reducer for a sprinkler in the related art, and FIG. 5B is a view illustrating a hexagonal reducer for a sprinkler in the related art.

FIG. 6 is a view illustrating a configuration of an integrated frame of the integrated bracket for fixing a sprinkler reducer according to the embodiment of the present invention.

FIG. 7 is a view illustrating a structure of a tightening/coupling part of the integrated bracket for fixing a sprinkler reducer according to the embodiment of the present invention.

FIGS. 8A and 8B are cross-sectional views illustrating states in which a horizontal length of the integrated bracket for fixing a sprinkler reducer according to the embodiment of the present invention is adjusted.

FIG. 9 is a view illustrating an integrated bracket for fixing a sprinkler reducer according to another embodiment of the present invention.

FIG. 10 is a view illustrating a state in which the tightening/coupling part according to the present invention is applied to one end of a quadrangular bar of a sprinkler reducer fixing bracket in the related art.

### DESCRIPTION OF MAIN REFERENCE NUMERALS OF DRAWINGS

100: Integrated bracket for fixing sprinkler reducer according to embodiment

100′: Integrated bracket for fixing sprinkler reducer according to another embodiment

10: Integrated frame

11: First quadrangular bar

12: Second quadrangular bar

13: Fixing member

20: Fixing unit according to embodiment

20′: Fixing unit according to another embodiment

21: First guide

22: Second guide

23: Third guide

24: Fourth guide

30: Tightening/coupling part

31: First leg portion

32: Second leg portion

33: Coupling groove

34: Tightening member

1: Ceiling steel frame

2: Sprinkler reducer

A: First coupling pin

B: Second coupling pin

C: Third coupling pin

D: Fourth coupling pin

### MODE FOR INVENTION

The detailed description of the present invention is provided to completely explain the present invention to a person with ordinary skill in the art. Throughout the specification, unless explicitly described to the contrary, when one component “comprises (includes)” another component or “characterized by” having a certain structure and a certain shape, this means that other components, structures, and shapes may be included without being excluded.

The present invention may be variously modified and may have various exemplary embodiments, and specific exemplary embodiments will be described in detail in the detailed description. However, the description of the exemplary embodiments is not intended to limit the contents of the present invention, but it should be understood that the present invention is to cover all modifications, equivalents and alternatives falling within the spirit and technical scope of the present invention.

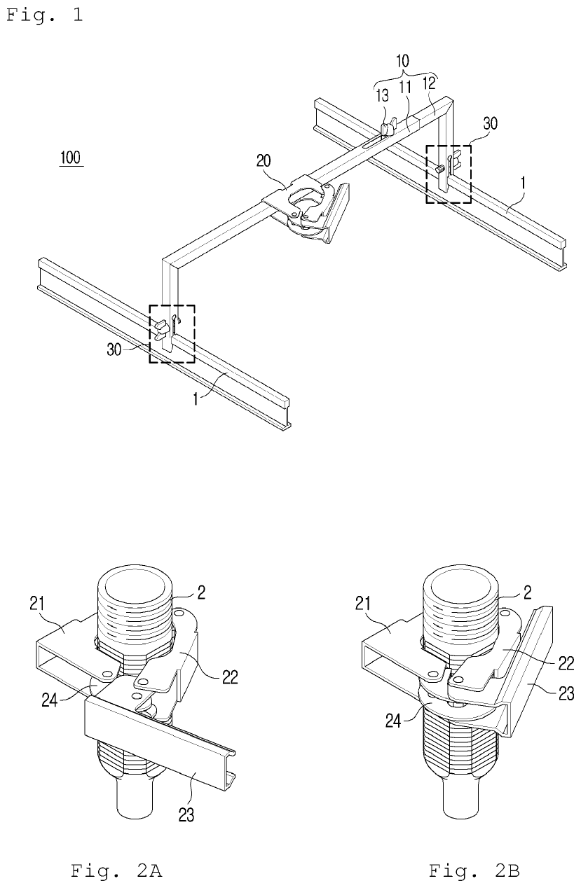

FIG. 1 is a view illustrating an integrated bracket 100 for fixing a sprinkler reducer according to an embodiment of the present invention. Referring to FIG. 1, the integrated bracket 100 for fixing a sprinkler reducer according to the present invention may be integrally coupled to ceiling steel frames 1 and include an integrated frame 10, a fixing unit 20, and tightening/coupling parts 30. The respective components will be described below.

The integrated frame 10 of the sprinkler reducer fixing bracket may perform both a function of a horizontal support for supporting the reducer fixing unit and a function of a side bracket coupled to the ceiling steel frame 1. To perform these functions, the integrated frame 10 may have a bar shape having two opposite ends each bent in a ‘¬’ shape. In this case, the tightening/coupling parts 30 to be described 240 below may be provided at the two opposite ends of the integrated frame 10, and the two opposite ends of the integrated frame 10 may be coupled to the ceiling steel frames 1.

In the embodiment, the integrated frame 10 may have a bar shape. For example, the integrated frame 10 may be provided in the form of a bar having various cross-sectional shapes such as quadrangular, pentagonal, and hexagonal shapes. FIG. 1 illustrates a quadrangular bar configured as a quadrangular column, but this is one embodiment, and the protection scope of the present invention is not intended to be limited thereto.

In the embodiment, the integrated frame 10 having two opposite ends each bent vertically in a ‘¬’ shape may be formed by cutting a straight quadrangular bar in a ‘V’ shape, perpendicularly bending the quadrangular bar, welding the adjoining cut portions, and plating the cut portions with zinc. In addition, the integrated frame 10 having two opposite ends each bent outward in a curved shape and a ‘¬’ shape may be formed by simply bending a straight quadrangular bar in a perpendicular direction.

In the embodiment, the integrated frame 10 may have a structure in which a plurality of quadrangular bars is inserted and coupled. Specifically, the integrated frame 10 may have a structure in which a first quadrangular bar 11, which has a predetermined space formed therein, and a second quadrangular bar 12, which has an outer surface compressed to have a reduced cross-section, are inserted and coupled to each other.

In the embodiment, the first and second quadrangular bars 11 and 12 may be configured as quadrangular bars having the same cross-sectional size, and a compressed lateral portion of the second quadrangular bar 12 may be inserted into one side of the first quadrangular bar 11. In this case, the first and second quadrangular bars 11 and 12 may perform a function of adjusting a horizontal length of the integrated frame 10. To perform the function, the first and second quadrangular bars 11 and 12 may slide in a longitudinal extending direction. In this case, the horizontal length of the integrated frame 10 may increase as the second quadrangular bar 12 inserted into the first quadrangular bar 11 slides in the state in which the first quadrangular bar 11 is fixed.

Meanwhile, in another embodiment, the first and second quadrangular bars 11 and 12 may be configured as quadrangular bars having different cross-section sizes, and the first and second quadrangular bars 11 and 12 may be inserted and coupled without performing compression molding on the second quadrangular bar 12.

In the embodiment, the integrated frame 10 may further include a fixing member 13 for fixing the positions of the first and second quadrangular bars 11 and 12. The fixing member 13 may be provided in the form of a bolt having a screw thread. In this case, the fixing member 13 may include a handle that enables a user to easily tighten or loosen the bolt. For example, when installing the integrated bracket 100 for fixing a sprinkler reducer on the particular ceiling steel frames 1, the user optionally adjusts the length of the integrated frame 10 to a distance between the spaced ceiling steel frames 1 by sliding the first and second quadrangular bars 11 and 12 and then fixes the first and second quadrangular bars 11 and 12 by means of the fixing member 13, thereby easily installing the integrated bracket 100 for fixing a sprinkler reducer.

In the embodiment, the tightening/coupling parts 30 configured to be coupled to the ceiling steel frames 1 may be provided at the two opposite ends of the integrated frame 10. The tightening/coupling parts 30 may be positioned at the two opposite ends of the integrated frame 10 and connect the ceiling steel frames 1 and the integrated frame 10. That is, in the state in which the tightening/coupling part 30 is integrated with the integrated frame 10, the tightening/coupling part 30 may perform the same function as the side bracket serving as a leg between the horizontal support and the ceiling steel frame 1 of the sprinkler reducer fixing bracket in the related art.

The fixing unit 20 of the sprinkler reducer fixing bracket may perform a function of a center bracket for fixing a sprinkler reducer 2 in a vertical direction. To perform the function, the fixing unit 20 may be configured by coupling four guides and define an opening into which the sprinkler reducer 2 is inserted. The sprinkler reducer 2 inserted into the opening may be compressed and fixed by the four guides.

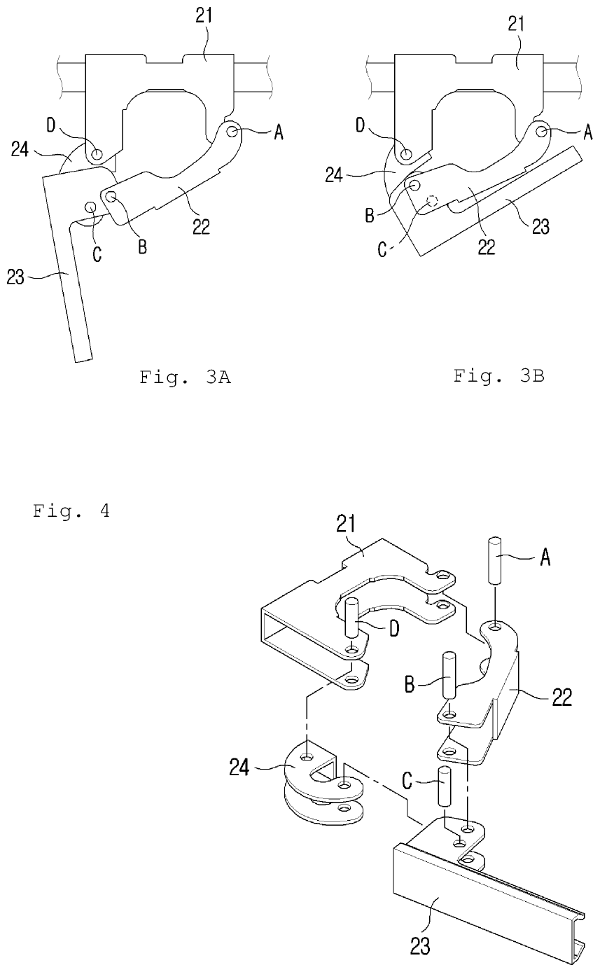

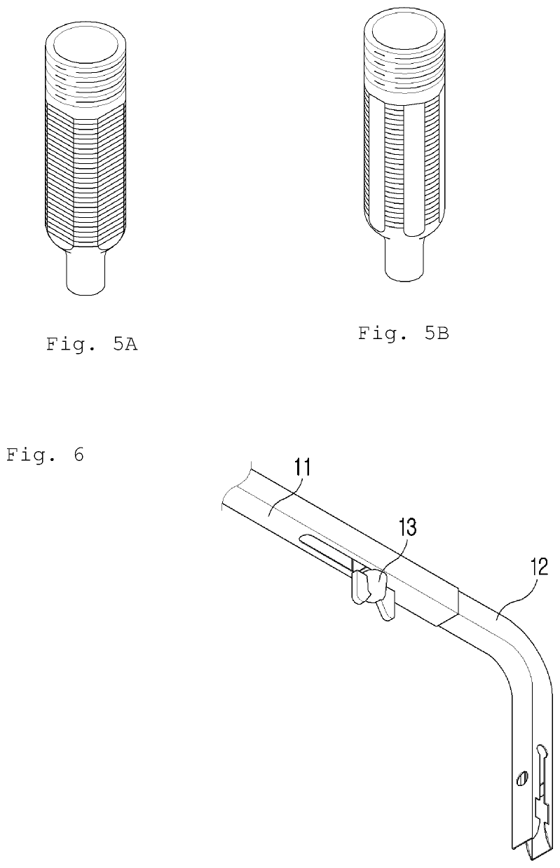

FIGS. 2A to 4 are views illustrating a configuration of the fixing unit 20 and a method of fixing the sprinkler reducer 2 according to the embodiment of the present invention. Specifically, FIGS. 2A and 3A are a perspective view and a cross-sectional view illustrating an opened state of the fixing unit 20 on which the sprinkler reducer 2 is mounted. FIGS. 2B and 3B are a perspective view and a cross-sectional view illustrating a closed state of the fixing unit 20 that fixes the sprinkler reducer 2. Further, FIG. 4 is an exploded view illustrating a configuration and structure of the fixing unit 20 according to the embodiment of the present invention. Referring to FIGS. 2A to 4, the fixing unit 20 may have a structure in which the four guides manufactured to have respective particular shapes are coupled by means of four pins. The configuration of the fixing unit 20 will be described below.

In the embodiment, the fixing unit 20 includes a first guide 21, a second guide 22, a third guide 23, and a fourth guide 24. The respective guides may be coupled by means of first to fourth coupling pins A, B, C, and D. In this case, all the first to fourth guides 21, 22, 23, and 24 may have one or more coupling holes and a three-surface structure including a pair of partition walls facing each other and a connecting surface for coupling the pair of partition walls.

The first guide 21 performs a function of coupling the integrated frame 10 and the fixing unit 20. To perform the function, the first guide 21 may accommodate the integrated frame 10 between the pair of partition walls and couple the integrated frame 10 by fitting. In this case, the pair of partition walls and the connecting surface of the first guide 21 may come into contact with the integrated frame 10. Specifically, one side of each of the pair of partition walls constituting the first guide 21 may be formed in a curved shape so that the first guide 21 may come into close contact with an outer surface of the sprinkler reducer 2 inserted into the opening of the fixing unit 20. Further, coupling holes respectively coupled to the second guide 22 and the fourth guide 24 may be provided at two opposite ends of one side of the first guide 21 formed in a curved shape.

The second guide 22 performs a function of pressing the sprinkler reducer 2 toward the first guide 21 using an external force. To perform the function, the first guide 21 and the third guide 23 are coupled to two opposite ends of the second guide 22, and one side of each of the pair of partition walls constituting the second guide 22 may be formed in a curved shape so that the second guide 22 comes into contact with the outer surface of the sprinkler reducer 2. Specifically, coupling holes respectively coupled to the first guide 21 and the third guide 23 may be provided at the two opposite ends of the pair of partition walls of the second guide 22 that face each other.

The third guide 23 functions as a handle to which an external force is applied. To perform the function, one side of the third guide 23 may be coupled to the second guide 22 and the fourth guide 24, and the other side of the third guide 23 may be provided in the form of a handle having a plate shape. Specifically, coupling holes coupled to the second guide 22 and the fourth guide 24 may be provided in the pair of partition walls of the third guide 23 that face each other, and the connecting surface may extend straight and be configured in the form of a handle having a plate shape.

When the third guide 23 approaches the second guide 22 by the external force, the fourth guide 24 functions as a flat spring for fixing the positions of the second guide 22 and the third guide 23. To perform the function, the fourth guide 24 may include a pair of partition walls having a ‘U’ shape, and the connecting surface formed at one side. Coupling holes respectively coupled to the first guide 21 and the third guide 23 may be provided at two opposite ends of the pair of partition walls having a ‘U’ shape.

In the embodiment, the first to fourth guides 21, 22, 23, and 24 may be coupled by means of the first coupling pin A for coupling the first guide 21 and the second guide 22, the second coupling pin B for coupling the second guide 22 and the third guide 23, the third coupling pin C for coupling the third guide 23 and the fourth guide 24, and the fourth coupling pin D for coupling the first guide 21 and the fourth guide 24. In this case, lengths of the first to fourth coupling pins A, B, C, and D may be determined to correspond to distances between the pairs of partition walls constituting the first to fourth guides 21, 22, 23, and 24. In the embodiment, the first coupling pin A and the second coupling pin B may have the same length, a length of the fourth coupling pin D may be shorter than the length of each of the first and second coupling pins A and B, and the third coupling pin C may have the shortest length.

Referring to FIGS. 2B and 3B, in the closed state of the fixing unit 20 according to the present invention, i.e., when the third guide 23 approaches the second guide 22 by the external force as the user applies the force to the third guide 23, the third coupling pin C is accommodated between the pair of partition walls constituting the second guide 22, and the position of the second coupling pin B may be moved to a portion between the coupling holes of the fourth guide 24. In this case, to completely fix the sprinkler reducer 2 by the fixing unit 20, an angle between the third coupling pin C, the second coupling pin B, and the fourth coupling pin D may be 45 degrees.

In addition, in the closed state of the fixing unit 20 according to the present invention, i.e., when the third guide 23 approaches the second guide 22 by the external force as the user applies the force to the third guide 23, the second guide 22 may primarily adjust the position of the sprinkler reducer 2 so that the outer surface of the sprinkler reducer 2 inserted into the opening of the fixing unit 20 comes into contact with the first guide 21, and the second guide 22 may secondarily press the sprinkler reducer 2. With the structure of the fixing unit 20 including the second guide 22, the user may use the integrated bracket 100 for fixing a sprinkler reducer according to the embodiment of the present invention for both the quadrangular reducer and the hexagonal reducer for a sprinkler.

In the embodiment, when the user installs the sprinkler reducer 2 using the integrated bracket 100 for fixing a sprinkler reducer, the fixing unit 20 may fix the sprinkler reducer 2 inserted into the opening while plastically deforming one surface of the integrated frame 10 that comes into contact with the sprinkler reducer 2.

FIGS. 5A and 5B are views illustrating the quadrangular reducer and the hexagonal reducer for a sprinkler in the related art that are typically used. The integrated bracket 100 for fixing a sprinkler reducer according to the embodiment of the present invention may be used for both the quadrangular reducer and the hexagonal reducer.

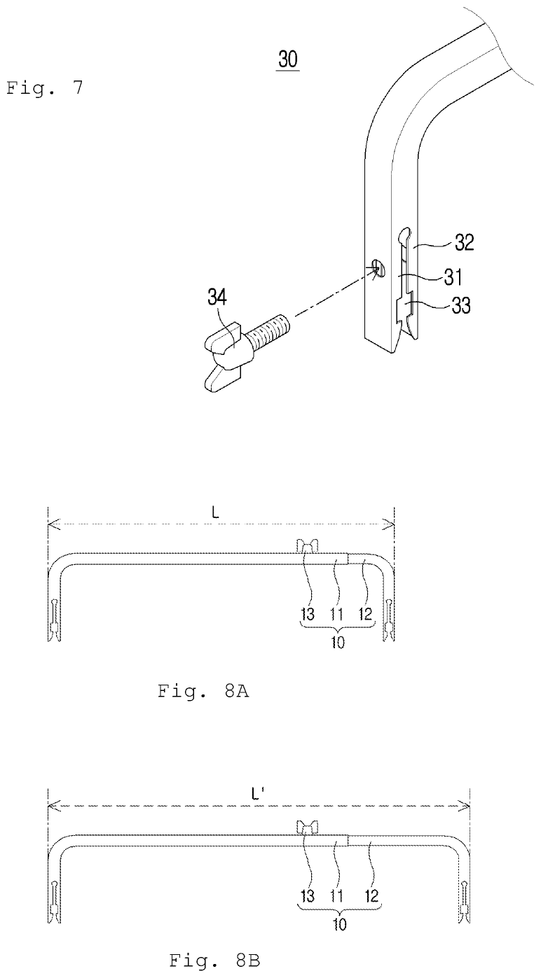

FIG. 6 is a view illustrating a configuration of the integrated frame 10 of the integrated bracket 100 for fixing a sprinkler reducer according to the embodiment of the present invention. Referring to FIGS. 2A and 2B, the integrated frame 10 is structured such that an opening formed at one side of the first quadrangular bar 11 extends by a predetermined length in a longitudinal direction, and the fixing member 13 is inserted into the opening. In this case, the second quadrangular bar 12 may slide, and the bolt of the fixing member 13 inserted into the opening may be tightened to press and fix the second quadrangular bar 12. Further, the position of the fixing member 13 may be changed within a size of the opening formed in the first quadrangular bar 11.

FIG. 7 is a view illustrating a configuration of the tightening/coupling part 30 of the integrated bracket 100 for fixing a sprinkler reducer according to the embodiment of the present invention. Referring to FIGS. 3A and 3B, the tightening/coupling part 30 may have a first leg portion 31 and a second leg portion 32 formed by dividing an end of the integrated frame 10 into two pieces. In this case, the tightening/coupling part 30 may fix the ceiling steel frame 1 inserted between the first leg portion 31 and the second leg portion 32 by allowing the first leg portion 31 and the second leg portion 32 to press each other.

In the embodiment, the tightening/coupling part 30 may have a concavo-convex coupling groove 33 to more strongly fix the ceiling steel frame 1 inserted between the first leg portion 31 and the second leg portion 32. The concavo-convex groove 33 may be changed in accordance with a shape of the ceiling steel frame 1 so as to engage with the ceiling steel frame 1. For example, in a state in which the end of the ceiling steel frame 1 having a ‘I’ shape is provided in the form of a quadrangular column, the concavo-convex groove 33 has a quadrangular cross-section to allow the end of the ceiling steel frame 1 inserted between the first leg portion 31 and the second leg portion 32 to engage with the concavo-convex groove 33.

In the embodiment, the tightening/coupling part 30 may include a tightening member 34 to increase the force for pressing the first leg portion 31 and the second leg portion 32. The tightening member 34 may penetrate an opening formed between the first and second leg portions 31 and 32 facing each other. In this case, the tightening member 34 may be provided in the form of a bolt having a screw thread and include a handle that enables the user to easily tighten or loosen the bolt. Therefore, as the user tightens the bolt, the tightening member 34 may compress the first and second leg portions 31 and 32 inward and additionally fix the ceiling steel frame 1 inserted between the first leg portion 31 and the second leg portion 32.

FIGS. 8A and 8B are cross-sectional views illustrating a state in which a horizontal length L or L′ of the integrated bracket 100 for fixing a sprinkler reducer according to the embodiment of the present invention is adjusted. FIG. 4A is a view illustrating a state before the second quadrangular bar 12 slides and illustrating the length L when the integrated frame 10 does not extend in the horizontal direction. FIG. 4B is a view illustrating a state in which the second quadrangular bar 12 is slid and illustrating the length L′ when the integrated frame 10 extends in the horizontal direction. Referring to FIGS. 4A and 4B, it can be seen that the horizontal length L or L′ is easily adjusted as the second quadrangular bar 12 of the integrated frame 10 slides. Therefore, when the integrated bracket 100 for fixing a sprinkler reducer according to the present invention is installed, the user may adjust the horizontal length of the integrated frame 10. Therefore, the integrated bracket 100 for fixing a sprinkler reducer according to the present invention may be easily installed on the optionally designed ceiling steel frame 1 without a separate additional facility.

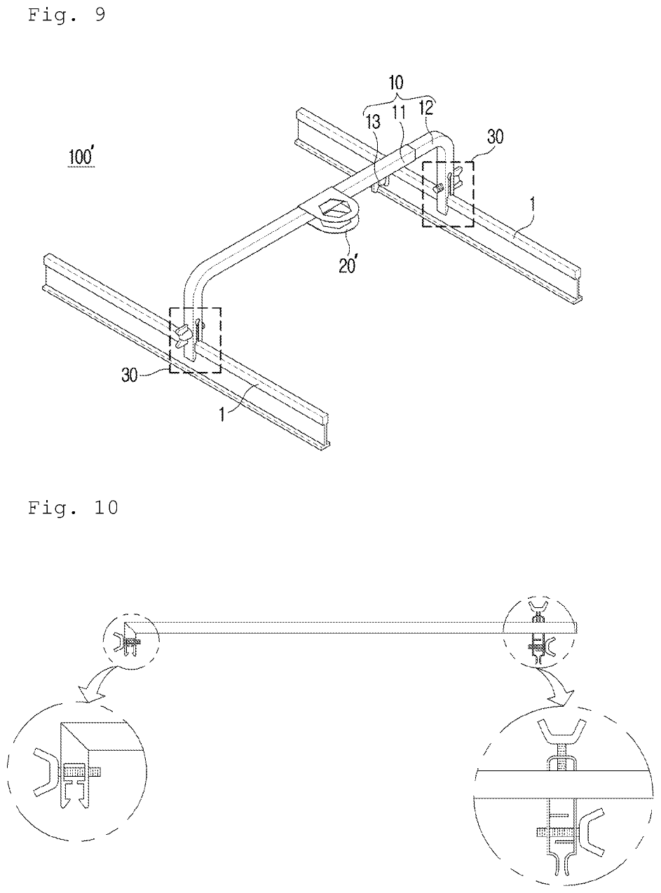

FIG. 9 is a view illustrating an integrated bracket 100′ for fixing a sprinkler reducer according to another embodiment of the present invention. Referring to FIG. 10, the integrated bracket 100′ for fixing a sprinkler reducer is different in the structure and configuration of the fixing unit 20 from the integrated bracket according to the aforementioned embodiment, and the integrated brackets of the two embodiments are identical to each other in terms of the remaining components. A fixing unit 20′ of the integrated bracket 100′ for fixing a sprinkler reducer according to another embodiment of the present invention may include a pair of partition walls facing each other and having an opening into which the sprinkler reducer is inserted, and a connecting portion connecting the partition walls.

In another embodiment, the fixing unit 20′ may be positioned at a central portion of the integrated frame 10 and coupled to the integrated frame 10. In this case, a part of each of the pair of partition walls and the connecting portion of the fixing unit 20′ may be in contact with the integrated frame 10. The contact portion may be coupled by means of a connecting member such as a screw or a bolt.

In another embodiment, the sprinkler reducer may be inserted into openings formed in the pair of partition walls of the fixing unit 20′. In this case, the inserted sprinkler reducer may be fixed as the outer wall of the inserted sprinkler reducer comes into contact with the openings, and the opening may be changed in accordance with the shape and size of the sprinkler reducer. For example, in a case in which the sprinkler reducer inserted into the fixing unit 20′ is provided in the form of a hexagonal column, the opening of the fixing unit 20′ is formed in a hexagonal shape, and the opening comes into contact with the outer wall of the sprinkler reducer inserted into the opening, such that the sprinkler reducer may be fixed.

In another embodiment, the fixing unit 20′ may have a protruding portion (an embossed portion) so that the fixing unit 20′ is coupled and fixed to the integrated frame 10 toward the inside where the partition walls face each other. In this case, the fixing unit 20′ may be coupled to the integrated frame 10 as the protruding portion is mounted at one side of the integrated frame 10 by the external force.

FIG. 10 is a view illustrating a state in which the tightening/coupling part 30 according to the present invention is applied to one end of a quadrangular bar of a sprinkler reducer fixing bracket in the related art. Referring to FIG. 10, the tightening/coupling part 30 may be applied to one end of the quadrangular bar that serves as a horizontal support for supporting a center bracket of the sprinkler reducer fixing bracket in the related art. Specifically, only one end of the integrated frame 10 of the integrated bracket 100 for fixing a sprinkler reducer according to the embodiment of the present invention is formed in a ‘¬’ shape, and a side bracket in the related art is used as the other end of the integrated frame 10, such that the tightening/coupling part 30 may be applied to the quadrangular bar of the sprinkler reducer fixing bracket in the related art. In this case, the tightening/coupling part 30 is fixed to the ceiling steel frame 1, and the position of the side bracket in the related art positioned at the other end is adjusted, such that the usage length in the horizontal direction of the quadrangular bar may be adjusted.

This example is only for describing that the tightening/coupling part 30 may be applied to the quadrangular bar of the sprinkler reducer fixing bracket in the related art to improve the user's processing convenience and reducing processing costs, and this example is not intended to limit the protection scope of the present invention.

While the present invention has been described above with reference to the exemplary embodiments, it may be understood by those skilled in the art that the present invention may be variously modified and changed without departing from the spirit and scope of the present invention disclosed in the claims.

1. An integrated bracket for fixing a sprinkler reducer, which is installed on one or more ceiling steel frames, the integrated bracket comprising:
an integrated frame having two opposite ends each having a bar shape bent in a ‘¬’ shape and coupled to the ceiling steel frame; and
a fixing unit positioned at one side of the integrated frame and configured to fix the reducer,
wherein the fixing unit is configured by coupling four guides and defines an opening into which the reducer is inserted, such that the reducer inserted into the opening is pressed and fixed by the four guides.

2. The integrated bracket of claim 1, wherein the fixing unit comprises:
a first guide coupled to the integrated frame by fitting;
a second guide configured to press the reducer inserted into the opening toward the first guide by an external force;
a third guide serving as a handle to which the external force is applied; and
a fourth guide serving as a flat spring configured to fix positions of the second and third guides when the third guide approaches the second guide by the external force, and
wherein the first to fourth guides each have one or more coupling holes and comprise a pair of partition walls facing each other, and a connecting surface for connecting the pair of partition walls.

3. The integrated bracket of claim 2, wherein the fixing unit comprises:
a first coupling pin configured to couple the first guide and the second guide;
a second coupling pin configured to couple the second guide and the third guide;
a third coupling pin configured to couple the third guide and the fourth guide; and
a fourth coupling pin configured to couple the first guide and the fourth guide, and
wherein a length of each of the first to fourth coupling pins corresponds to a distance between the pair of partition walls constituting each of the first to fourth guides.

4. The integrated bracket of claim 3, wherein when the third guide approaches the second guide by the external force, the third coupling pin is accommodated between the pair of partition walls constituting the second guide, and a position of the second coupling pin is moved to a portion between the coupling holes of the fourth guide.

5. The integrated bracket of claim 2, wherein when the third guide approaches the second guide by the external force, the second guide adjusts a position of the reducer so that an outer surface of the reducer inserted into the opening comes into close contact with the first guide, and the second guide presses the reducer.

6. The integrated bracket of claim 1, wherein the integrated frame comprises:
a first quadrangular bar having a space formed therein; and
a second quadrangular bar having an outer surface compressed to have a reduced cross-section at one side thereof, and
wherein a compressed lateral portion of the second quadrangular bar is inserted into and coupled to one side of the first quadrangular bar.

7. The integrated bracket of claim 6, wherein the first and second quadrangular bars slide in a longitudinal direction, and positions of the first and second quadrangular bars are fixed by a fixing member.

8. The integrated bracket of claim 1, wherein the integrated frame comprises tightening/coupling parts provided at two opposite ends, and the tightening/coupling parts each have a shape divided into a first leg portion and a second leg portion.

9. The integrated bracket of claim 8, wherein the tightening/coupling part has a concavo-convex coupling groove so that the ceiling steel frame is fixed by being inserted between the first leg portion and the second leg portion.

10. The integrated bracket of claim 8, wherein the tightening/coupling part comprises a tightening member configured to allow the first and second leg portions to press each other.
